(19) United States
(12) Patent Application Publication
(10) Pub. No.: US 2008/0161011 A1
(43) Pub. Date: Jul. 3, 2008

(54) METHOD ENABLING INDOOR LOCAL POSITIONING AND MOVEMENT TRACKING IN WIFI CAPABLE MOBILE TERMINALS

(75) Inventors: Thomas S. Babin, Lake Zurich, IL (US); Mohammad S. Bani Hani, Lindenhurst, IL (US); Tom Mathew, Skokie, IL (US); Guoshu Song, Schaumburg, IL (US); Yinyan Wang, Palatine, IL (US); Xiaohua Wu, Kildeer, IL (US); Chuntao (Charles) Zhang, Streamwood, IL (US)

Correspondence Address: PRASS & IRVING LLP, 2661 Riva Road, Bldg. 1000, Suite 1044, ANNAPOLIS, MD, 21401, US

(73) Assignee: Motorola, Inc., Schaumburg, IL (US)

(21) Appl. No.: 11/617,772

(22) Filed: Dec. 29, 2006

(51) Int. Cl. H04Q 7/20

(52) U.S. Cl. 455/456.1

(57) ABSTRACT

A method, apparatus, and electronic device for determining a location of a mobile device are disclosed. A receiver may asynchronously receive an access signal from at least three access points of a wireless local area network with the mobile device. A processor may measure an access signal strength for the access signal for each access point. A transmitter may transmit the access signal strengths to a location server to determine the location of the mobile device.

### 1. FIELD OF THE INVENTION

The present invention relates to a method and system for locating mobile telecommunication devices. The present invention further relates to locating mobile telecommunication devices using the access points of a wireless local area network.

### 2. INTRODUCTION

The Federal Communications Committee (FCC) has issued rules to enhance 911 emergency coverage and improve the reliability of wireless 911 service, by requiring accurate location data to be provided by the mobile devices to 911 dispatchers. This enhanced 911 has been divided into two phases. Phase one merely requires that carriers provide the antenna, or wireless base station, from which an emergency call has been received. Phase two involves a much greater degree of accuracy, requiring carriers to provide a mobile device's location to within 50 to 300 meters.

Wireless carriers, such as cellular telephone service providers, are currently able to determine within a general degree of accuracy the general location of a wireless device. For example, a cellular telephone user can be tracked by determining the signal strength that is being received by nearby transceiver cells and triangulating the user's position. The problem with using this method is the level of accuracy available is not up to the level required by the new FCC rules. Further, if a person is inside a building this can affect cellular coverage, leading to distortions in the positioning of a user. What is needed is a method of tracking wireless devices to a greater degree of accuracy.

### SUMMARY OF THE INVENTION

A method, apparatus, and electronic device for determining a location of a mobile device are disclosed. A receiver may asynchronously receive an access signal from at least three access points of a wireless local area network with the mobile device. A processor may measure access signal strength for the access signal for each access point. A transmitter may transmit the access signal strengths to a location server to determine the location of the mobile device.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates in a diagram one embodiment of a simplified scheme for a wireless network to locate a mobile device.

FIG. 2 illustrates in a floorplan one embodiment of a building that may implement the present invention.

FIG. 3 illustrates one embodiment of a self-locating mobile wireless communications device in a public network.

FIG. 4 illustrates one embodiment of a method by which the mobile device may determine its location in a public network.

FIG. 5 illustrates one embodiment of a method by which the location server may determine the location of the mobile device in a public network.

FIG. 6 illustrates one embodiment of a method by which the mobile device may determine its location in a private network.

FIG. 7 illustrates a possible configuration of a computer system to act as a mobile system or location server to execute the present invention.

### DETAILED DESCRIPTION OF THE INVENTION

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

The present invention comprises a variety of embodiments, such as a method, an apparatus, and an electronic device, and other embodiments that relate to the basic concepts of the invention. The electronic device may be any manner of computer, mobile device, or wireless communication device.

A method, apparatus, and electronic device for determining a location of a mobile device are disclosed. A receiver may asynchronously receive an access signal from at least three access points of a wireless local area network with the mobile device. A processor may measure access signal strength for the access signal for each access point. A transmitter may transmit the access signal strengths to a location server to determine the location of the mobile device.

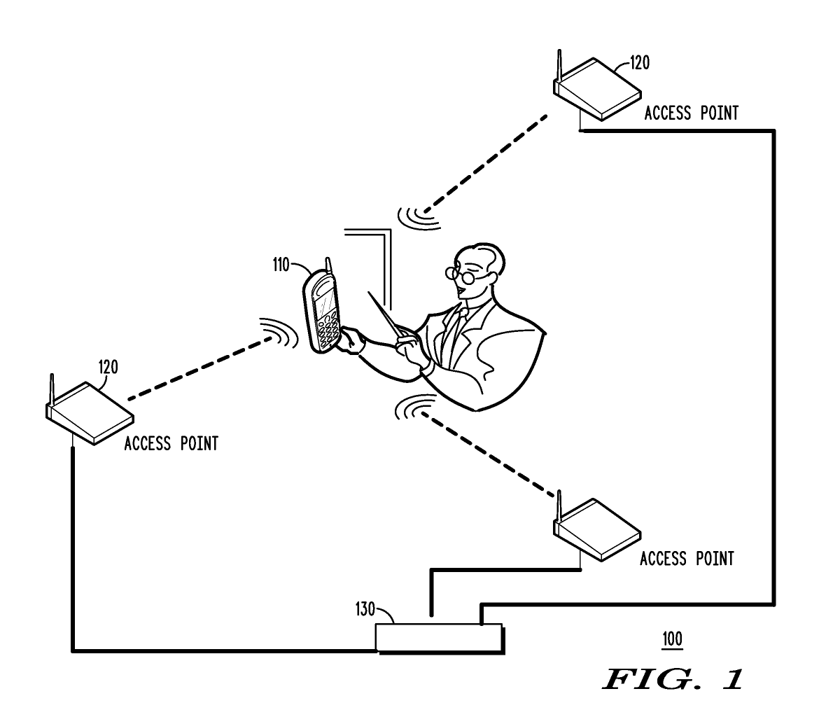

FIG. 1 illustrates in a diagram one embodiment of a simplified scheme 100 for a wireless network to locate a mobile device 110. The mobile device 110 may be any mobile device that communicates with a larger network. The mobile device 110 may interact with a wireless local area network (WLAN) set up in the area in which the mobile device 110 is located. The WLAN may be a private network or a public network. A public network is open to any user with equipment that is capable of accessing a WLAN. A private network is only open to certain registered users. A private network may be visible to non-members, but inaccessible, or might be hidden from non-members. A private network is generally accessible by providing the proper encryption key. The encryption key may have been previously provided by the network administrator or may be provided by a device that is synchronized with the network. The WLAN is accessible by a series of access points 120. These access points 120 broadcast signals readable by the mobile device and receive signals from those devices. The mobile device 110 may be connected to a location server 130. In one embodiment, the mobile device 110 may be connected to the location server 130 via a cellular network. If the network is a public network, the mobile device 110 may connect to the location server 130 via the access points 120 of the WLAN.

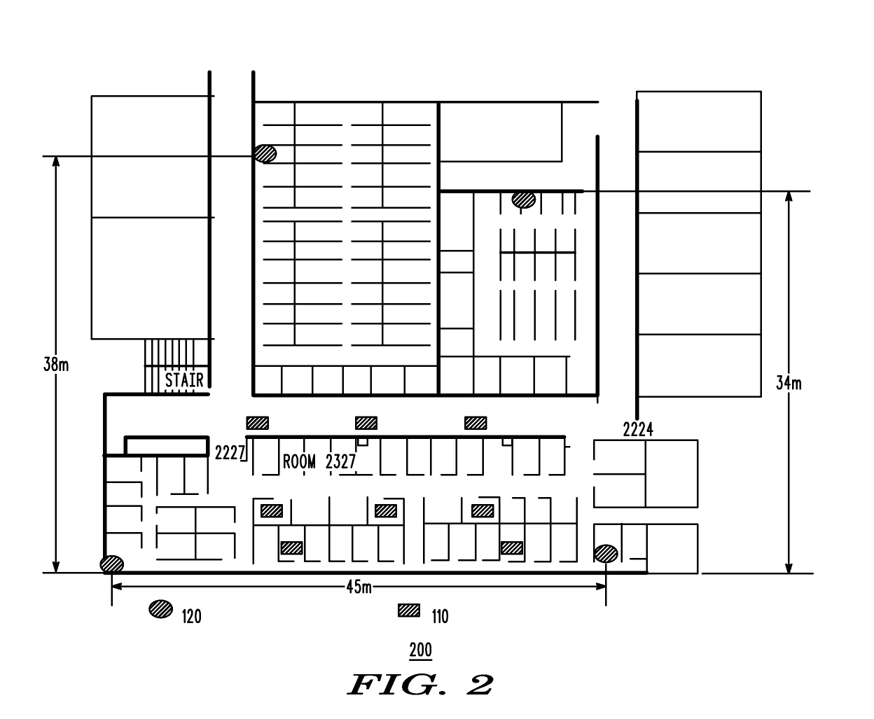

The present invention is ideal for use in buildings hosting a WLAN. FIG. 2 illustrates in a floorplan one embodiment of a building 200 that may implement the present invention. Access points 120 are established throughout the building, making for easy access by the mobile devices 110.

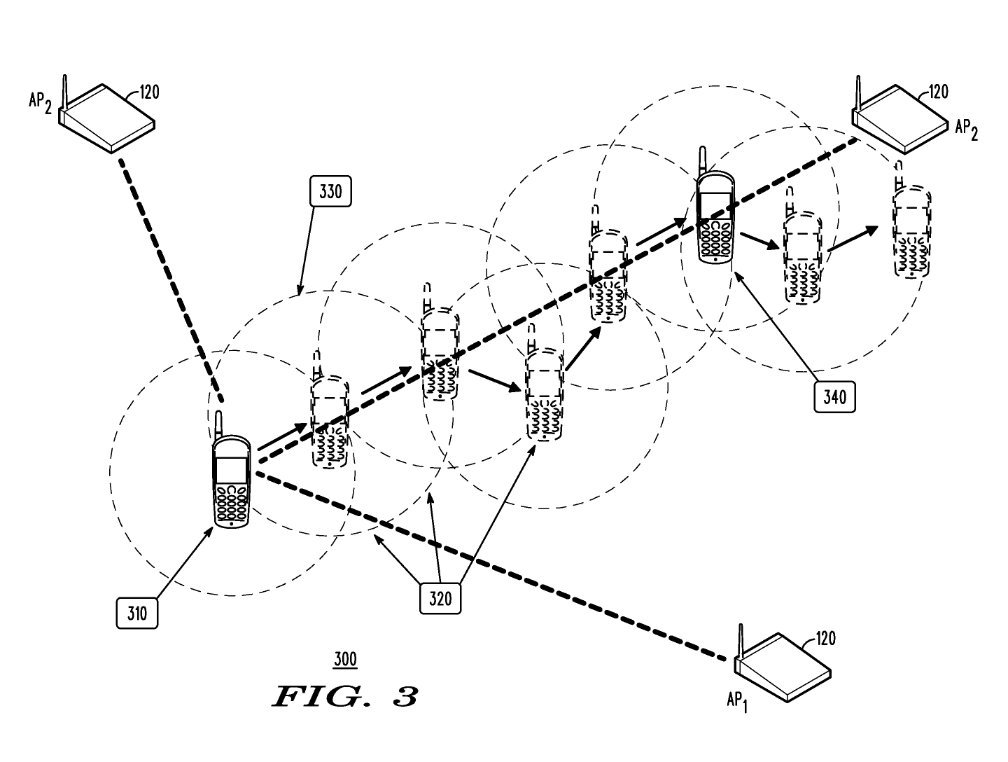

FIG. 3 illustrates one embodiment of a self-locating mobile wireless communications device in a public network 300. An initial reference location 310 is established by determining the initial location using asynchronous radio signals measurements in access points 120. At least three access points 120 receive a signal from the mobile device 110 and use the signal strength of the mobile device to determine the initial reference location 310. As the mobile device 110 moves about within the network, the mobile device 110 samples the signal strength of a beacon transmitted by the access points to determine a new location 320 of the mobile device 110. The new location 320 is compared to the reference location 310 to determine the accuracy of the new location 320. Allowances are made for a scanning radius 330, which takes into account how much the mobile device is moved between measurements. The scanning radius may be determined using the average walking speed of a human. The scanning radius may be made adjustable depending on the location of the device, such as taking into account a greater scanning radius nearer to any elevators or other conveyances that may travel faster than humans. If the new location 320 is within the scanning radius 330, the new location 320 becomes the reference location 340. An adjusted reference location 340 may be determined by using the access points 120 if necessary.

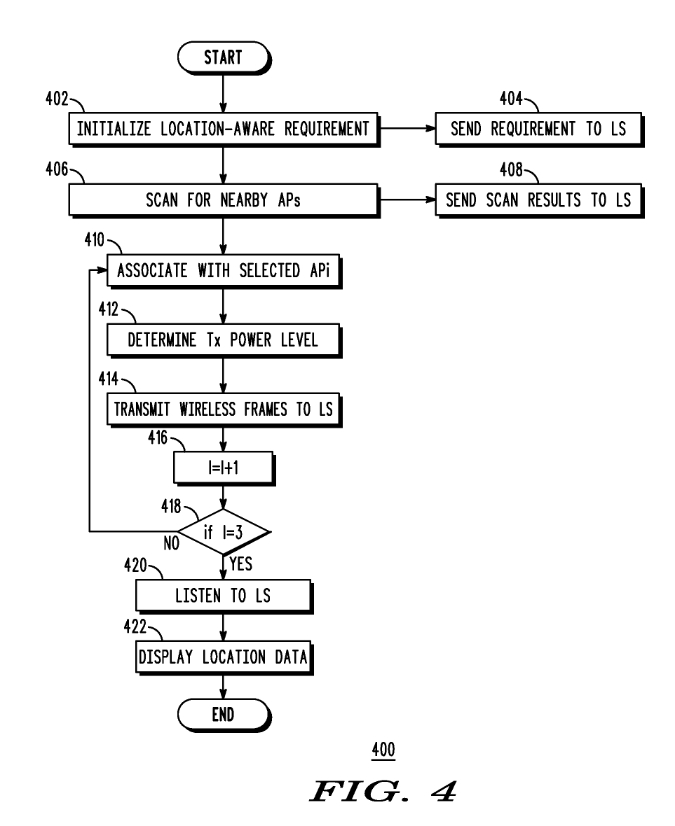

FIG. 4 illustrates one embodiment of a method 400 by which the mobile device 110 may determine its location in a public network. The mobile device (MD) 110 may initialize the location-aware requirement mode (Block 402), sending a location-aware requirement request to the location server (LS) 130 (Block 404). The MD 110 may then scan for available access points (APs) 120 in the WLAN (Block 406), sending the results to the LS 130 (Block 408). The MD 110 may associate with a first of the selected APs 120 (Block 410), and determine the transmission power of the MD 110 (Block 412). The MD 110 may then transmit wireless frames using a constant transmission power to the LS 130 (Block 414). The MD 110 then iterates to the next AP 120 (Block 416), until a sufficient quantity of APs 120 have been sampled (Block 418). While three APs 120 have been used in the present example, more may be used if so desired. The MD 110 may then receive the location data from the LS (Block 420), and display it to the user (Block 422).

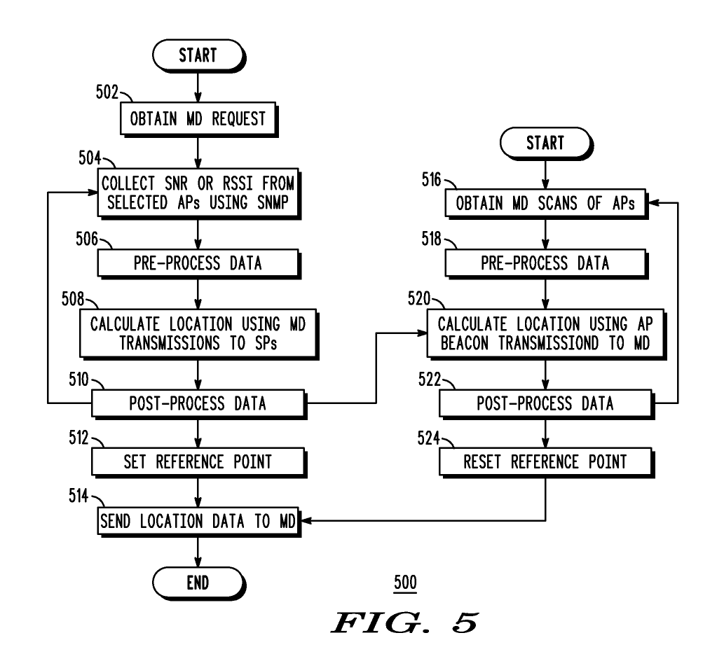

FIG. 5 illustrates one embodiment of a method 500 by which the LS 130 may determine the location of the MD 110 in a public network. The LS 130 may receive a request for a location from a MD 110 (Block 502). The request may include data regarding the APs 120 in the area of the MD 110. The LS 130 collects signal to noise ratio (SNR) or received signal strength indication (RSSI) data from the selected APs 120 using a simple network management protocol (SNMP) (Block 504). The LS 130 preprocesses the data by sorting and grouping the transmission data received from the APs and filtering the noise from the transmitted data (Block 506). The LS 130 determines the position of the MD 110 by using the transmissions from the MD 110 to the APs 120 (Block 508). The LS 130 locates the MD 110 by applying the appropriate weights to each AP 120, calculating the radio frequency transmission attenuation to determine the distance from each AP to the MD 110, and using that data to triangulate the position. The LS 130 checks the position against the last reference point and determines if the new location is statistically likely (Block 510). A new position is statistically likely if it is close to the old reference point or is a distance that may be reasonably achieved in the time since the last reference point was determined. If the new location does not deviate beyond statistical likelihood form the reference point, the LS 130 sets the new position as the new reference point (Block 512). The LS 130 sends the new location data to the MD 110 (Block 514).

Once a reference point has been established, the LS 130 may update the position of the MD 110 continuously. The LS 130 may receive scan reports from the MD 110 of the signal strength of the beacons of the APs 120 in the area (Block 516). The LS 130 preprocesses these scan reports, account for noise and other distortions (Block 518). The LS 130 determines the position of the MD 110 by using these transmissions from the APs 120 to the MD 110 (Block 520). The triangulation process similar to one used by the LS 130 to generate the reference point may be used to determine the MD 110 location. The difference is that the transmissions from the APs 120 to the MD 110 are used instead of the transmissions from the MD 110 to the APs 120. The LS 130 checks the position against the last reference point and determines if the new location is statistically likely (Block 522). If the new location is statistically likely but different from the last reference point, the LS 130 sets the new location as the reference location (Block 524). The LS 130 sends the new location data to the MD 110 (Block 514).

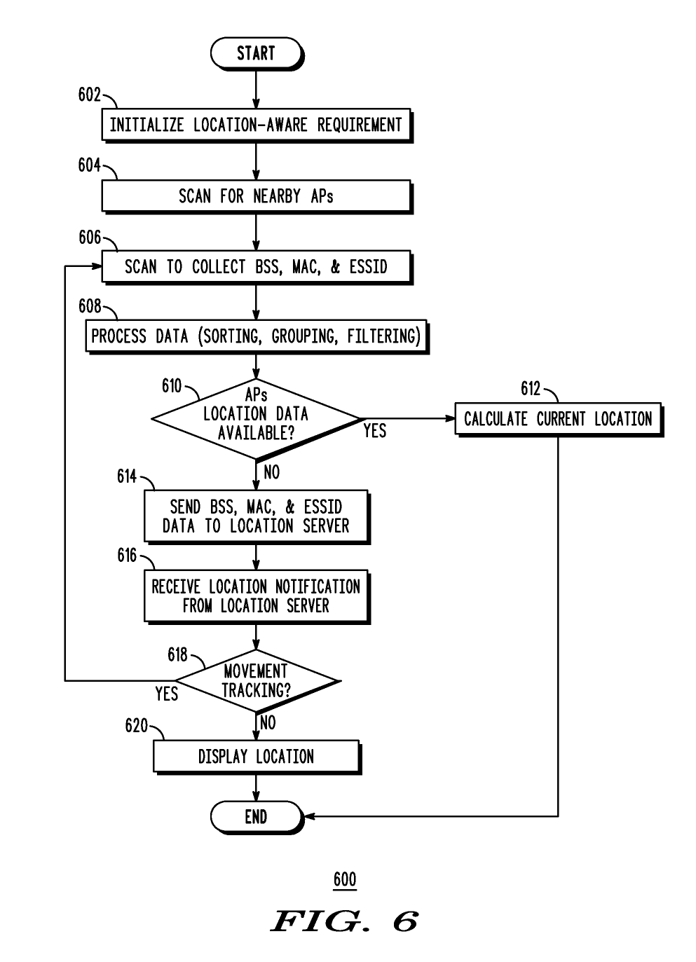

FIG. 6 illustrates one embodiment of a method 600 by which the MD 110 may determine its location in a private network. The MD 110 may initialize the location-aware requirement mode (Block 602). The MD 110 may then scan for available access points APs 120 in the WLAN (Block 604). The MD 110 collects the appropriate data about the APs 120 (Block 606). The appropriate data may include the beacon signal strength (BSS) of each AP, the media access control (MAC) used by each AP, an extended service set identifier (ESSID), or other data. The MD 110 may use an existing wireless extension tool to collect this data. The MD 110 may process the collected data, such as sorting, grouping, and noise filtering (Block 608). If the location data of the selected APs 120 is available to the MD 110 (Block 610), the MD 110 may calculate its current location by triangulating the BSS for each AP 120 (Block 612). The location data may be an extension of the MAC or other access point identifiers. If the necessary location data of the selected APs 120 is not available to the MD 110 (Block 610), the MD 110 may send the collected data to the LS 130 (Block 614). The LS 130 may use the MAC or ESSID data to determine the location of the access points, and use that information to triangulate the position of MD 110 based on the collected BSS. The MD 110 may then receive its position from the LS 130 (Block 616). If the MD 110 is tracked as moving (Block 618), the collection and triangulation are repeated. If the MD 110 is not moving (Block 618), the MD 110 displays the location to the user (Block 620).

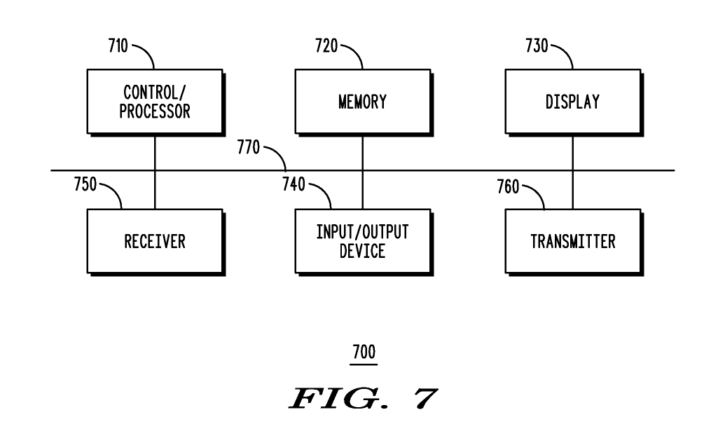

FIG. 7 illustrates a possible configuration of a wireless mobile system 700 to act as a mobile system or location server to execute the present invention. The computer system 700 may include a controller/processor 710, a memory 720, display 730, input/output device interface 740, a receiver 750, and a transmitter 760, connected through bus 770. The computer system 700 may implement any operating system, such as Windows or UNIX, for example. Client and server software may be written in any programming language, such as ABAP, C, C++, Java or Visual Basic, for example.

The controller/processor 710 may be any programmed processor known to one of skill in the art. However, the decision support method can also be implemented on a general-purpose or a special purpose computer, a programmed microprocessor or microcontroller, peripheral integrated circuit elements, an application-specific integrated circuit or other integrated circuits, hardware/electronic logic circuits, such as a discrete element circuit, a programmable logic device, such as a programmable logic array, field programmable gate-array, or the like. In general, any device or devices capable of implementing the decision support method as described herein can be used to implement the decision support system functions of this invention.

The memory 720 may include volatile and nonvolatile data storage, including one or more electrical, magnetic or optical memories such as a RAM, cache, hard drive, CD-ROM drive, tape drive or removable storage disk. The memory may have a cache to speed access to specific data.

The Input/Output interface 740 may be connected to one or more input devices that may include a keyboard, mouse, pen-operated touch screen or monitor, voice-recognition device, or any other device that accepts input. The Input/Output interface 740 may also be connected to one or more output devices, such as a monitor, printer, disk drive, speakers, or any other device provided to output data.

The receiver 750 may be any type of receiver that may receive broadcast data signals. Similarly, the transmitter 760 may be any type of receiver that may transmit any data signals to another device. The receiver 750 and the transmitter 760 may be separate devices or a single dual-purpose device.

Although not required, the invention is described, at least in part, in the general context of computer-executable instructions, such as program modules, being executed by the electronic device, such as a general purpose computer. Generally, program modules include routine programs, objects, components, data structures, etc. that perform particular tasks or implement particular abstract data types. Moreover, those skilled in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like.

Embodiments may also be practiced in distributed computing environments where tasks are performed by local and remote processing devices that are linked (either by hardwired links, wireless links, or by a combination thereof through a communications network.

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments of the invention are part of the scope of this invention. For example, the principles of the invention may be applied to each individual user where each user may individually deploy such a system. This enables each user to utilize the benefits of the invention even if any one of the large number of possible applications do not need the functionality described herein. It does not necessarily need to be one system used by all end users. Accordingly, the appended claims and their legal equivalents should only define the invention, rather than any specific examples given.

We claim:

1. A method for locating a mobile device, comprising:
asynchronously receiving an access signal from each of at least three access points of a wireless local area network with the mobile device;
measuring an access signal strength for each access signal; and
transmitting the access signal strengths to a location server to determine a first location of the mobile device.

2. The method of claim 1, wherein the wireless local area network is a public network.

3. The method of claim 2, further comprising:
transmitting a mobile signal to the at least three access points; and
receiving from the location server a reference location based on a first triangulation of the mobile signals.

4. The method of claim 3, further comprising storing the reference location.

5. The method of claim 4, further comprising:
comparing the reference location to the first location.

6. The method of claim 1, further comprising identifying each position of the at least three access points based on media access layer data.

7. The method of claim 1, further comprising identifying positions of the at least three access points based on access point identifiers for each access point.

8. The method of claim 1, wherein the wireless local area network is a private network.

9. A mobile telecommunications apparatus that self-locates, comprising:
a receiver that asynchronously receives an access signal from each of at least three access points of a wireless local area network;
a processor that measures an access signal strength for each access signal; and
a transmitter that transmits the access signal strengths to a location server to determine a first location.

10. The mobile telecommunications apparatus of claim 9, wherein the transmitter transmits a mobile signal to the at least three access points and the receiver receives from the location server a reference location based on a first triangulation of the mobile signals.

11. The mobile telecommunications apparatus of claim 10, further comprising a memory that stores the reference location.

12. The mobile telecommunications apparatus of claim 11, wherein the processor compares the first location to the reference location.

13. The mobile telecommunications apparatus of claim 9, wherein the processor identifies each position of the at least three access points based on media access layer data.

14. The mobile telecommunications apparatus of claim 9, wherein the processor identifies positions of the at least three access points based on access point identifiers for each access point.

15. An electronic device that self-determines its own location, comprising:
a receiver that asynchronously receives an access signal from each of at least three access points of a wireless local area network;
a processor that measures an access signal strength for each access signal; and
a transmitter that transmits the access signal strengths to a location server to determine a first location.

16. The electronic device of claim 15, wherein the transmitter transmits a mobile signal to the at least three access points and the receiver receives from the location server a reference location based on a first triangulation of the mobile signals.

17. The electronic device of claim 16, further comprising a memory that stores the reference location.

18. The electronic device of claim 17, wherein the processor compares the first location to the reference location.

19. The electronic device of claim 15, wherein the processor identifies each position of the at least three access points based on media access layer data.

20. The electronic device of claim 15, wherein the processor identifies positions of the at least three access points based on access point identifiers for each access point.
